(19) United States
(12) Patent Application Publication
(10) Pub. No.: US 2006/0104074 A1
(43) Pub. Date: May 18, 2006

(54) Vehicle body

(76) Inventors: Robert E. Boniface, Bloomfield Hills, MI (US); Young Sun Kim, Troy, MI (US); Hyun Soo Kim, Utica, MI (US)

Correspondence Address: KATHRYN A MARRA;General Motors Corporation, Legal Staff, Mail Code 482-C23-B21, P.O. Box 300, Detroit, MI, 48265-3000, US

(21) Appl. No.: 11/223,815

(22) Filed: Sep. 9, 2005

Related U.S. Application Data
(60) Provisional application No. 60/608,584, filed on Sep. 10, 2004.

(51) Int. Cl. B60Q 1/26; B60K 11/00

(52) U.S. Cl. 362/496; 180/68.1

(57) ABSTRACT

A front or rear of a vehicle body defines an air inlet opening, with a selectively illuminatable light source at least partially surrounding the air inlet opening. The light source may include a metallic dielectric coating on a surface thereof. In another aspect of the invention, a vehicle body includes a fascia defining a generally centrally located air inlet opening and a pair of generally laterally located air inlet openings, with one generally laterally located air inlet opening located on each side of the generally centrally located air inlet opening. The vehicle body further includes a pair of headlight assemblies, with one headlight assembly located on each side of the generally centrally located air inlet opening, preferably vertically higher than the generally located air inlet openings.

### CROSS-REFERENCE TO RELATED APPLICATIONS

This application claims the benefit of U.S. Provisional Application 60/608,584, filed Sep. 10, 2004, and which is hereby incorporated by reference in its entirety.

### TECHNICAL FIELD

The present invention relates to vehicular air inlets.

### BACKGROUND OF THE INVENTION

Vehicle bodies provide shelter for passengers and cargo. A vehicle body typically defines the exterior surface of most of the vehicle, and many functional components for driver interaction with the vehicle's operating environment are mounted to the body or are part of the body. For example, side rearview mirrors that a driver employs to detect objects along the side of the vehicle are typically mounted near A-pillars. Turn signal lights for signalling driver intentions to other drivers are found at the forward face of a body and at a rearward face of a body. Headlights are mounted at the forward face of a body to illuminate the road at night. Brake lights are found at the rear face of a body.

Numerous components on the vehicle generate heat in performing their intended functions. Accordingly, cooling systems are provided that typically include a liquid coolant directed past the heat-generating components to transfer the excess heat to a heat-dissipating component, such as a radiator. Outside air is then directed over the radiator to lower the coolant temperature and the coolant is then re-directed to the heat-generating component, creating a cooling circuit. Cooling systems are typically designed with a single radiator, centrally located in a frontward portion of the vehicle.

### SUMMARY OF THE INVENTION

The present invention provides a vehicle body defining an air inlet opening, with a selectively illuminatable light source at least partially surrounding the air inlet opening. In one aspect of the invention, the light source also at least partially defines the air inlet opening. In another aspect of the invention, the light source fully surrounds the air inlet opening, with the light source preferably defining an aperture, such that the air inlet opening remains at least partially unblocked when surrounded by the light source. The air inlet opening may be defined by a front or a rear of the vehicle body, and may include a metallic dielectric coating on a surface thereof.

The present invention also provides a vehicle body including a member defining a generally centrally located air inlet opening and a pair of generally laterally located air inlet openings, with one generally laterally located air inlet opening located on each side of the generally centrally located air inlet opening. The vehicle body further includes a pair of headlight assemblies, with one of the headlight assemblies located on each side of the generally centrally located air inlet opening. The headlight assemblies are preferably positioned vertically higher than the generally located air inlet openings, and may be directly above the generally laterally located air inlet openings. The generally centrally located air inlet opening may include a grille. The vehicle body preferably includes a pair of selectively illuminatable light sources, with one light source at least partially surrounding each generally laterally located air inlet opening. The light sources may at least partially define the generally laterally located air inlet openings.

The above features and- advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic front view of a vehicle body; and

FIG. 2 is a schematic rear view of the vehicle body of FIG. 1.

### DESCRIPTION OF THE PREFERRED EMBODIMENTS

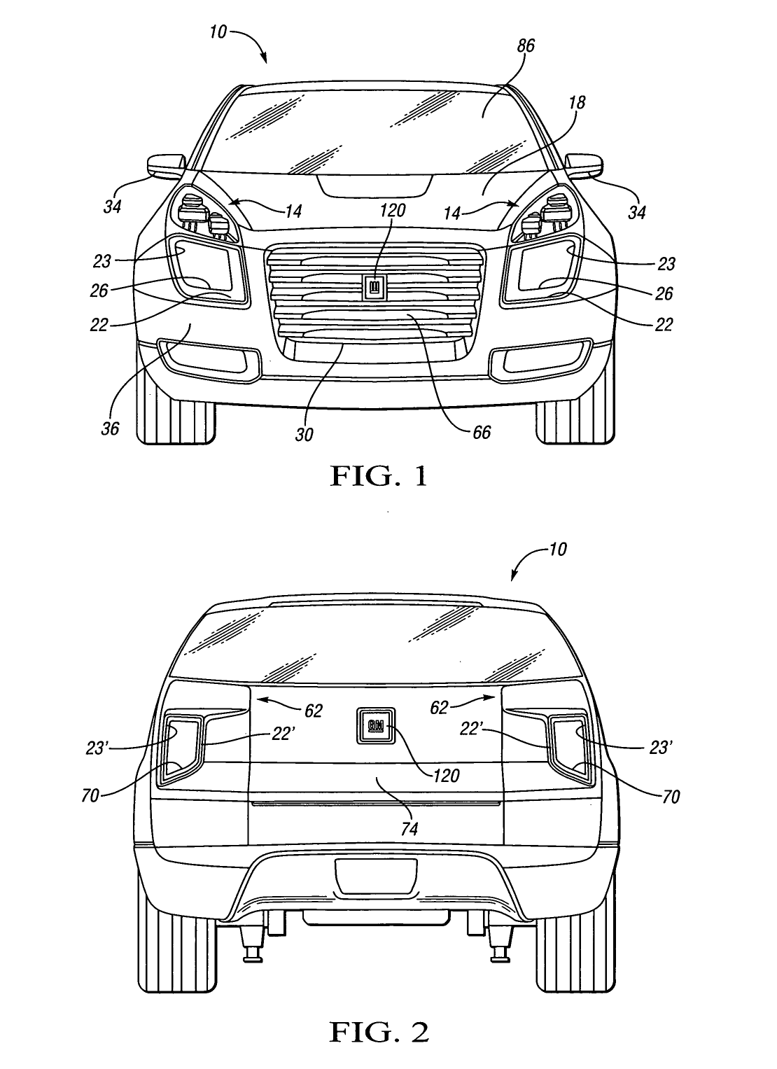

Referring to the figures, wherein like reference numerals refer to like components, FIG. 1 shows a front view of a vehicle body 10. The vehicle body 10 includes headlight assemblies 14, a hood 18, front illuminatable members 22, a generally centrally located air inlet opening 30, generally laterally located air inlet openings 26, and side mirrors 34.

Front fascia 36 includes apertures for accommodating the air inlet openings 26, 30. The air inlet openings 26, 30 provide fluid communication between the atmosphere and a vehicle radiator or radiators (not shown) for cooling a vehicle powertrain (not shown). A grille 66 is preferably situated within air inlet opening 30. Air inlet openings 26 may include a mesh screen or other such cover therein within the scope of the claimed invention. Air inlet openings 26 preferably have a smaller surface area than air inlet opening 30, and are positioned on opposite sides of air inlet opening 30 adjacent and below headlight assemblies 14.

Preferably, the generally centrally located air inlet opening 30 provides air flow to a high-temperature radiator, while the generally laterally located air inlet openings 26 provide air flow to a low-temperature radiator. However, the air inlet openings 26, 30 may be used to cool a single radiator, or for other purposes, such as passenger compartment ventilation, within the scope of the present invention. The arrangement of the air inlet openings 26, 30 depicted and described herein is particularly advantageous when used with fuel cell vehicles, which typically require more cooling surface area exposed to air flow for convective heat transfer than traditional motor vehicles.

In the present context, an “illuminatable member” is a member that emits light, as opposed to merely reflecting light, that is visible to an observer at the exterior of the vehicle. In the embodiment depicted, each illuminatable member 22 is a clear plastic lens with one or more light sources, such as incandescent bulbs or light emitting diodes, positioned on one side of the lens and positioned to direct light through the lens such that the light is visible to an observer at the exterior of the vehicle. However, those skilled in the art will recognize other illuminatable members that may be employed within the scope of the invention. For example, “at least one illuminatable member at least partially surrounding the air inlet” may include a plurality of light emitting diodes cooperating to at least partially surround an air inlet.

Illuminatable members 22 are preferably configured to operate as turn signals to signal a vehicle operator's intentions. The illuminatable members 22 at least partially surround may at least partially define the respective air inlet openings 26. In the embodiment depicted in FIG. 1, the illuminatable members 22 are shown fully surrounding and defining the respective air inlet openings 26. As such, the illuminatable members 22 include an aperture 23 formed therein, such that the air inlet openings 26 are open to the outside environment even when completely surrounded by the illuminatable members 22. However, the illuminatable members 22 need not define the air inlet openings 26 to practice the present invention. One or both of the illuminatable members 22 can include a full metallic dielectric coating on an outward surface, thereby allowing the illuminatable members 22 to illuminate as desired, while providing the illuminatable members 22 with a reflective, chrome-like appearance when not illuminated.

Referring to FIG. 2, which shows a rear view of the vehicle body 10, the body 10 further includes two rear brake light assemblies 62. Air inlet openings 70 on the rear face of the vehicle body 10 preferably provide fluid communication between the atmosphere and a rear cooling system (not shown). A radiator (not shown) operates as a heat exchanger to cool one or more vehicle heat generating components, such as a left wheel motor, a power supply, a power inverter module, a traction battery for powering the wheel motor and a like wheel motor on the right side of the vehicle. Outside air is pulled through the air inlet openings 70 to cool the radiator.

Rear illuminatable members 22′ at least partially surround and may at least partially define the rear air inlet openings 70. In the embodiment shown in FIG. 2, the illuminatable members 22′ are shown fully surrounding the air inlet openings 70. As such, the illuminatable members 22′ include an aperture 23′ formed therein, such that the air inlet openings 70 remain at least partially unblocked when surrounded by the illuminatable members 22′. The rear air inlet openings 70, the rear illuminatable members 22′, and the rear brake light assemblies 62 may be integrated modular units which may be mounted to a rear liftgate 74 or connected to a fixed body member that is not a closure panel. Optionally, the rear brake light assemblies 62 each include a cover with a full metallic dielectric coating for a reflective appearance when the brake lights are off. Additionally, the illuminatable members 22′ can include a full metallic dielectric coating on a surface thereof to provide a reflective appearance when the illuminatable members 22′ are not illuminated.

As shown in FIGS. 1 and 2, an emblem 120 provided with a light source (not shown) behind it may be included on either the front or the rear of the vehicle body 10, or both. The emblem 120 is preferably comprised of clear plastic. Portions of the emblem 120, preferably text and certain aesthetic features, have a full metallic dielectric coating thereon so that light from the light source can pass therethrough. The dielectric coating is reflective and chrome-like in appearance when no light from the light source is transmitted through the emblem 120. Emblem 120 is shown on the grill 66 in FIG. 1, and on the rear liftgate 74 in FIG. 2.

While the best modes for carrying out the invention have been described in detail, those familiar with the art to which this invention relates will recognize various alternative designs and embodiments for practicing the invention within the scope of the appended claims.

1. A vehicle body comprising:
an air inlet opening defined by said vehicle body; and
at least one selectively illuminatable member at least partially surrounding said air inlet opening.

2. The vehicle body of claim 1, wherein said at least one selectively illuminatable member at least partially defines said air inlet opening.

3. The vehicle body of claim 1, wherein said air inlet opening is defined by a front of said vehicle body.

4. The vehicle body of claim 1, wherein said air inlet opening is defined by a rear of said vehicle body.

5. The vehicle body of claim 1, wherein said at least one selectively illuminatable member fully surrounds said air inlet opening.

6. The vehicle body of claim 5, wherein said at least one selectively illuminatable member defines an aperture, such that said air inlet opening remains at least partially unblocked when surrounded by said at least one selectively illuminatable member.

7. The vehicle body of claim 1, wherein said at least one selectively illuminatable member includes a metallic dielectric coating on a surface thereof.

8. A vehicle body comprising:
a member defining a generally centrally located air inlet opening and a pair of generally laterally located air inlet openings, with each of said pair of generally laterally located air inlet openings being on a respective, opposite side of said generally centrally located air inlet opening; and
a pair of headlight assemblies, with each of said pair of headlight assemblies being located higher than said pair of laterally located air inlet openings.

9. The vehicle body of claim 8, wherein said headlight assemblies are positioned directly above said generally laterally located air inlet openings.

10. The vehicle body of claim 8, further comprising a grille within said centrally located air inlet opening.

11. The vehicle body of claim 8, further comprising:
a first selectively illuminatable member surrounding a first of said pair of laterally located air inlet openings; and a second selectively illuminatable member surrounding a second of said pair of laterally located air inlet openings.

12. A vehicle body comprising:
a pair of generally laterally located air inlet openings defined by said vehicle body;
a pair of headlight assemblies; and
a pair of selectively illuminatable members, with a first of said pair of selectively illuminatable members at least partially surrounding a first of said pair of generally laterally located air inlet openings, and a second of said pair of selectively illuminatable members at least partially surrounding a second of said pair of air inlet openings.
